(19) United States
(12) Patent Application Publication
(10) Pub. No.: US 2004/0021041 A1
(43) Pub. Date: Feb. 5, 2004

(54) Sparkjet actuator

(76) Inventors: Kenneth R. Grossman, Olney, MD (US); Bohdan Z. Cybyk, Columbia, MD (US); David M. VanWie, Brookeville, MD (US)

Correspondence Address: Benjamin Y. Roca, Esq., Office of Patent Counsel, The Johns Hopkins University, Applied Physics Laboratory, 11100 Johns Hopkins Road, Laurel, MD, 20723-6099, US

(21) Appl. No.: 10/464,160

(22) Filed: Jun. 18, 2003

Related U.S. Application Data
(60) Provisional application No. 60/389,542, filed on Jun. 18, 2002.

(51) Int. Cl. B64C 21/04; B64C 3/00

(52) U.S. Cl. 244/207

(57) ABSTRACT

The Spark Jet can manipulate high-speed flows without moving aerodynamic structures and generates exhaust streams that can penetrate supersonic (as well as subsonic) boundary layers without the need for active mechanical components. The Spark Jet comprises a chamber with embedded electrodes and a discharging orifice. High-chamber pressure may be generated by rapidly heating the gas inside SparkJet using an electrical or other useful discharge. The pressure may be relieved by exhausting the heated air though an orifice.

### CROSS REFERENCE TO RELATED APPLICATIONS

This application claims the benefit of U.S. Provisional Application No. 60/389,542, filed Jun. 18, 2002, the contents of which are incorporated by reference herein.

### FIELD OF THE INVENTION

This invention pertains to the field of aerodynamic structures, and more particularly the manipulation of high-speed flows without moving aerodynamic structures. More specifically, the present embodiment relates to a system that is of a solid-state device including a small chamber with embedded electrodes and a discharge orifice. It may contain no moving parts. The high chamber pressure may be generated by rapidly heating the gas inside the SparkJet using an electrical discharge. Exhausting the heated air through an orifice relieves the pressure.

### BACKGROUND OF THE INVENTION

Over the years, there has been plenty of development and application of advanced optical diagnostics in high-speed flows. Detailed investigations of the physics of high speed and Reynolds number flows of interest in propulsion and aerodynamics have been conducted. Examples of flows investigated in recent years range from compressibility effects in mixing layers and jets to passive control of mixing and noise in supersonic jets via streamwise vortices to the effects of extra strain rates on the structure of supersonic boundary layers.

Distinguished concepts for high speed flow control in aerospace and turbo-machinery applications advocate a retrospective look onto pre-CFD time theoretical results for special airfoils, wings, bodies, and internal flows because such results reveal theoretically idealized behavior for several aspects in practical applications. Practical application of active flow control is dependent upon the development of robust actuators that are reliable, low cost, responsive, and consume little power. Many different actuators have been developed and demonstrated through various active flow control applications. Actuator types include Lorentz-force actuators, monolithic piezoelectric flap actuators, synthetic jet actuators, and combustion-driven jet actuators.

In order to extend previously demonstrated flow control techniques to higher flow velocity regimes, it is necessary to develop mechanisms to activate process control equipment by use of pneumatic, hydraulic, or electronic signals with sufficient momentum to successfully interact with and manipulate high-speed flows. In other words, there has been a long felt need for actuators that can operate with and maneuver high-speed flows.

Effective manipulation of a flow field can lead to a number of significant benefits to aerospace vehicle systems, including enhanced performance, maneuverability, payload and range, as well as lowered overall cost. These macro benefits are directly achievable through the application of flow control technology to impact fluid phenomena such as transition, turbulence, and flow separation on a micro-scale. Practical application of active flow control is dependent upon the development of robust actuators.

The SparkJet is a potentially revolutionary system for high-speed flow control that is being developed at the Johns Hopkins University Applied Physics Laboratory (JHU/APL). The SparkJet produces a synthetic jet with high exhaust velocities and holds the promise of manipulating high-speed flows without moving aerodynamic structures.

### SUMMARY OF THE INVENTION

The present invention relates to an improved solid-state device that consists of a small chamber with embedded electrodes and a discharge orifice. It may contain no moving parts. High-chamber pressure may be generated by rapidly heating the gas inside the SparkJet using an electrical discharge. The pressure may be relieved by exhausting heated air through an orifice, which may be an opening or window in a side or end wall of a waveguide or cavity resonator through which energy is transmitted.

Joule heating by electric discharge is initiated and controlled using a grid with main current flowing from cathode to anode. The cathode may not be initially heated and breakdown may be induced by high electric fields. Also, the discharge may occur at ambient conditions instead of in a vacuum tube. The invention may incorporate Mach number contours predicted by CFD⁺⁺ at t=15 μs. The Mach number is the ratio of the speed of a body or of a point on a body with respect to the surrounding air or other fluid, or the ratio of the speed of a fluid, to the speed of sound in the medium.

The desired technology demonstration is that of flow control steering resulting from the management of flow separation at tapered external surfaces. One application of this embodiment of the invention is the development of a micro-actuated flow control system for enhanced aerodynamic performance of small, highly maneuverable, high-speed vehicles.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is one embodiment of a SparkJet device illustrating the device body that comprises of orifice, cathode, anode, and ceramic material;

FIG. 2 illustrates an embodiment of a single cycle of SparkJet operation consisting of three distinct stages: energy deposition, discharge, and recovery;

FIG. 3 illustrates an embodiment of a schematic of the SparkJet configuration that is a first order model of the SparkJet operation;

FIG. 4 illustrates one graphical representation of the effect of energy deposition on SparkJet operating characteristics;

FIG. 5 illustrates one representation diagram depicting the three-dimensional computational mesh generated by using the ICEM-CFD package;

FIG. 6 is one schematic of the Mach number contours predicted by CFD⁺⁺ for the baseline quiescent flow case at t=150 μs presenting a snapshot of the flowfield;

FIG. 7 is one embodiment which illustrates temperature and velocity time histories predicted by CFD⁺⁺;

FIG. 8 is one representation of the SparkJet device with illustrations of the anode, grid, and cathodes;

FIG. 9 shows the Schlieren photos of SparkJet discharge illustrating an embodiment of the operation of a single cycle of the SparkJet.

### DETAILED DESCRIPTION OF THE PREFERRED EMBODIMENT

Although the present invention has been described in connection with the preferred form of practicing it, those of ordinary skill in the art will understand that many modifications can be made thereto within the scope of the claims that follow.

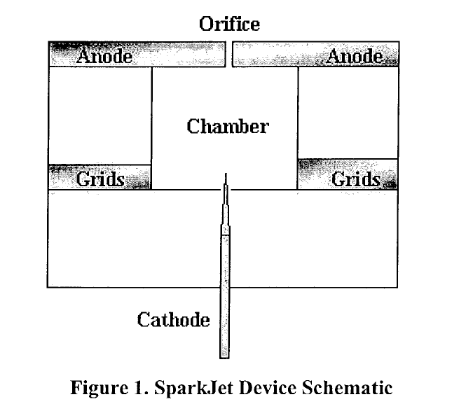

FIG. 1 is one schematic of the SparkJet device. The device body may be made from an electrical insulator such as a ceramic. In one embodiment, three electrodes are fashioned into the device: an anode, a sharp cathode, and a grid. Main discharge current flows from cathode to anode and is initiated by a small cathode-to-grid discharge. Experimental devices have been fabricated with a chamber diameter of 6 mm, height of 5.5 mm, and a volume of approximately 1.5E-7m³.

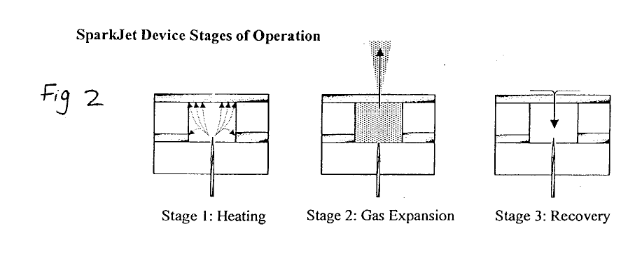

FIG. 2 demonstrates in this emobodiment the different stages of the SparkJet operation cycle consisting of the energy deposition, discharge, and recovery stage. Stage 1 may be the energy deposition stage where the cathode-to-anode potential is raised to a level less than that required to initiate a cathode-to-anode electric discharge but larger than that required to initiate a cathode-to-grid discharge. One manner to trigger the device is performed by flashing the cathode-to-anode potential onto the grid through a low-power, current-limited switch. Once the grid is pulsed, a streamer discharge may initiate between the cathode and grid. This low power discharge generates a larger pool of electrons, enabling the breakdown from cathode to anode. Since the anode is not current-limited, the majority of current flows from the cathode to the anode, thereby heating the bulk chamber gas. The electric discharge may be short in duration, approximately two orders of magnitude shorter than the gas expulsion stage in the present embodiment. The energy deposited heats the chamber gas to high temperature with a corresponding rise in chamber pressure.

In one embodiment, stage 2 of FIG. 2 represents the discharge stage. A small orifice in the chamber allows for expulsion of the now-pressurized chamber gas. As flow begins, the orifice may quickly choke, and air may be expelled from the device at high speed. As the chamber gas expands, chamber pressure and temperature may drop. The orifice eventually un-chokes and the exhaust velocity may decrease in the present embodiment.

The third section of FIG. 2 demonstrates the recovery stage in the present embodiment. The now-depleted chamber cools rapidly, which draws fresh air from outside the device into the chamber. This completes the cycle and the device is ready for operation again. Cycles are repeated to produce a sustainable synthetic jet. During the recovery stage, heat is lost through the wall of the SparkJet. As heat is lost, fresh air is drawn into the control volume such that nearly ambient pressure is maintained. The amount of energy that needs to be transferred to the walls can be determined from: ΔE=ρ₂V(e₂−e₁) Assuming for the current embodiment that the heat transfer can be modeled in terms of a film coefficient:

$$h = \frac{{Q}^{′}}{{A}_{surface} ( {T}_{w} - T )}$$

And assuming for the current embodiment that a lumped heat capacity system model can be used, the temperature within the control volume can be determined from:

$$\frac{T - {T}_{0}}{{T}_{2} - {T}_{0}} = {ⅇ}^{- t / τ}$$

Therefore, the recovery time may be decreased (hence the operating frequency may be increased).

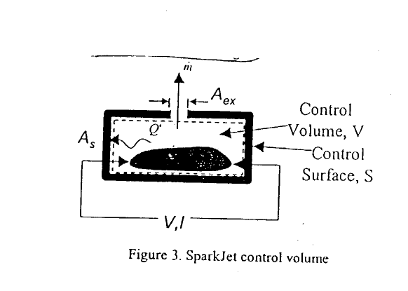

In one embodiment, FIG. 3 applies the energy equation to the control volume shown. In this figure, q is the heat added per unit mass to the control volume and q' is the heat lost from the control volume through the surface of the control volume. The energy equation is:

$${∯ \int }_{v} qp ⅆ V - {∮ \int }_{s} {q}^{′} ⅆ S - {∮ \int }_{s} PV \cdot ⅆ S = {∯ \int }_{v} \frac{\partial }{\partial t} [ p ( e + V2 / 2 ) ] ⅆ V + {∮ \int }_{s} p ( e + V2 / 2 ) V \cdot ⅆ S$$

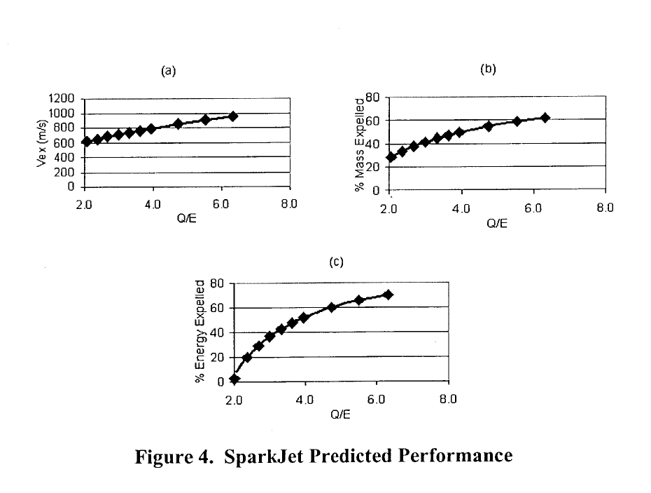

In one embodiment, FIG. 4 is a graphical representation of the effect of energy deposition on SparkJet operating characteristics. As seen in FIG. 4a, the velocity of the discharge jet (Vₑₓ) ranges from approximately 600 to 950 m/s at the beginning of the discharge stage. The amount of the initial mass expelled and the fraction of the deposited energy expelled are shown in FIGS. 4b and 4c. At high-energy deposition levels, the SparkJet may be very efficient in transferring electrical energy into kinetic energy of the injected mass.

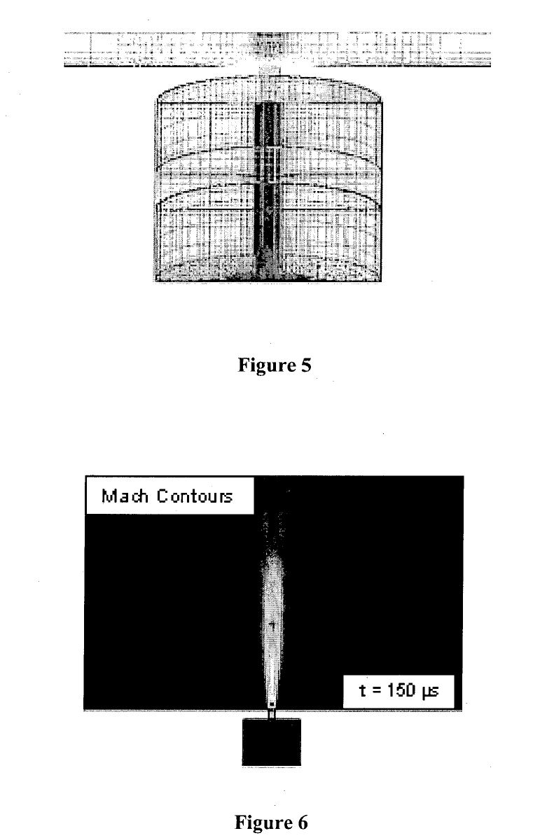

In one embodiment, FIG. 5 shows a three-dimensional computational mesh for the initial SparkJet simulation that was generated using the ICEM-CFD grid generation package. It consists of a cylindrical chamber 6 mm in diameter and 5 mm in height. The intake/exhaust of the chamber is facilitated by a 1 mm high orifice (0.25 mm diameter) situated atop the chamber. To allow flexibility in boundary condition specification, the individual components of the SparkJet chamber were assigned separate identifiers.

In one embodiment, FIG. 6 shows a snapshot of the flowfield predicted by CFD⁺⁺ for the baseline quiescent flow case—a turbulent, three-dimensional Navier-Stokes computation with constant (isothermal) wall temperatures of 288K. In this figure, the color scale progresses from blue (min) to red (max) corresponding to Mach numbers from 0 to 2.5.

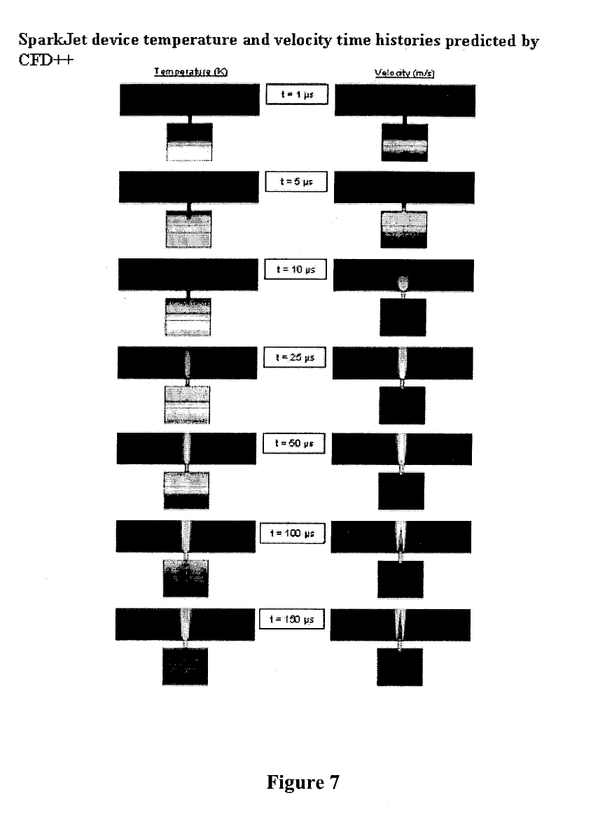

In one embodiment, FIG. 7 presents a time history of the temperature and velocity fields within and around the SparkJet chamber over the course of the first 150 μs as predicted by CFD⁺⁺ after instantaneous, constant-density heat addition to the bottom 40% of the chamber volume. In this embodiment, the gray scale progresses from min to max corresponding to temperatures from 288 to 3000 K and velocities from 0 to 1500 m/sec.

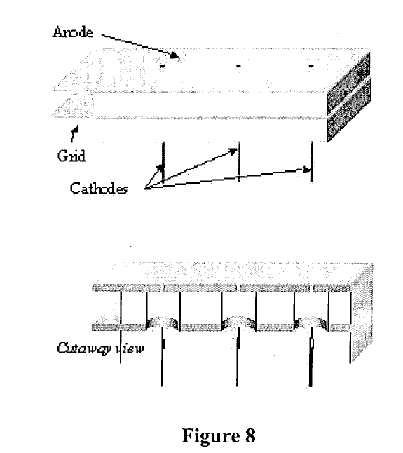

In another embodiment, FIG. 8 shows a schematic of a fabricated device comprising three independent SparkJet chambers.

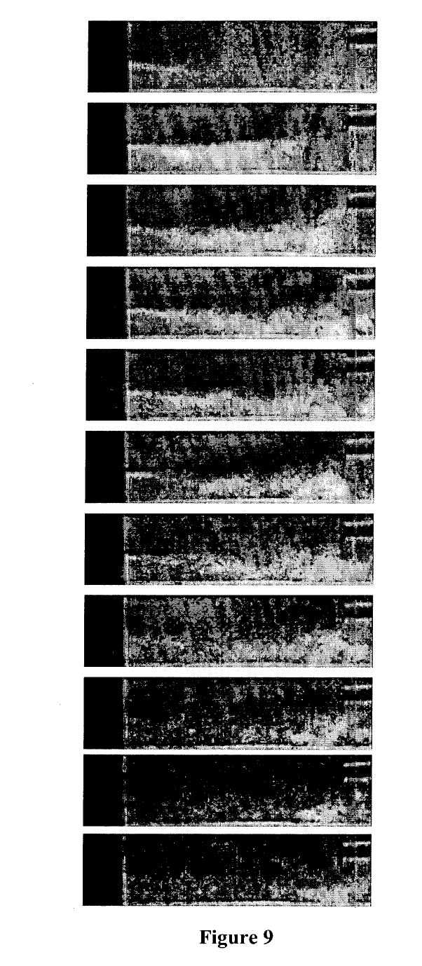

In another embodiment, FIG. 9 demonstrates the operation of a single cycle of the SparkJet where the input power is limited by the electrical equipment to approximately 0.02 J deposited in 2 μs which is an order or magnitude below the current target of 0.2 J but is sufficient to demonstrate device operation.

Accordingly, it is not intended that the scope of the invention in any way be limited by the above description, but instead be determined entirely by reference to the claims that follow.

What is claimed is:

1. An apparatus for high chamber pressure comprising of a chamber with at least one embedded electrode, a gas and a discharge orifice.

2. The apparatus as set forth in claim 1, wherein the device body is made from an electrical insulator material

3. The apparatus as set forth in claim 2, wherein the electrical insulator material is ceramic.

4. The apparatus as set forth in claim 1, wherein said apparatus heats the gas.

5. The apparatus as set forth in claim 4, wherein said heating is performed using a discharge.

6. The apparatus as set forth in claim 5, wherein the discharge is electrical.

7. The apparatus as set forth in claim 1, wherein the electrode comprises an anode, a cathode and a grid.

8. The apparatus as set forth in claim 7, wherein said cathode produces a non-uniform electric field near the electrode surface.

9. The apparatus as set forth in claim 1, wherein said apparatus has no moving parts.

10. The method of generating exhaust streams which comprises the steps of:
(a) heating a gaseous chamber;
(b) explusion of gas;
(c) replenishing chamber with fresh air

11. The method as described in claim 10, wherein no fuel is used

12. The method as described in claim 10, where no valving is used.
